(19) United States
(12) Patent Application Publication
(10) Pub. No.: US 2018/0373723 A1
(43) Pub. Date: Dec. 27, 2018

(54) METHOD AND SYSTEM FOR APPLYING A MACHINE LEARNING APPROACH TO RANKING WEBPAGES' PERFORMANCE RELATIVE TO THEIR NEARBY PEERS

(71) Applicant: Unbounce Marketing Solutions Incorporated, Vancouver, CA (US)

(72) Inventors: Thomas Scott LEVI, Vancouver (CA); Jordan Tyler DAWE, Vancouver (CA); Yosem Simon REICHERT-SWEET, Richmond (CA)

(21) Appl. No.: 16/018,900

(22) Filed: Jun. 26, 2018

Related U.S. Application Data
(60) Provisional application No. 62/525,523, filed on Jun. 27, 2017.

(51) Int. Cl. G06F 17/30; G06F 17/27; G06K 9/62; G06N 7/00; G06N 99/00

(52) U.S. Cl. CPC G06F 17/3089; G06F 17/2785; G06N 99/005; G06N 7/00; G06K 9/6215

(57) ABSTRACT

A cloud-based, machine learning method and system to compare, rank and/or predict an example webpage's performance (such as conversion rate for webpages in an online marketing campaign) relative to its closest peers. The closest peers are selected from a sample set of webpages for which performance is known. A topic model is constructed from a modeling set of webpages, based on their content. A topic vector for the example webpage and for each webpage in the sample set is determined based upon the constructed topic model. The example webpage's closest peers are determined by the distance/similarity measure between the topic vector of the example webpage and of each webpage of the sample set. The method and system can be applied to one or a plurality of example webpages in order to assess webpages that are underperforming relative to their closest peers.

### RELATED APPLICATION

This application claims priority to U.S. Provisional Patent Application No. 62/525,523, filed on Jun. 27, 2017, which is incorporated in its entirety by this reference.

### FIELD OF THE INVENTION

The present invention relates to the fields of applied machine learning and marketing optimization. More particularly, the present invention relates to the technical field of applied machine learning for marketing optimization respecting webpages.

### BACKGROUND OF THE INVENTION

When marketers create webpages (which can include landing pages, homepages, mobile webpages, etc.) for their online marketing campaigns, they can evaluate and analyze the performance statistics for their own webpages, for example, by viewing conversion rates per webpage. However, at present, marketers have no way of determining how their webpages are performing relative to those webpages' peers. It is contemplated that such information would be of considerable value and use to the marketers. This would allow them to optimize their workflow, so that they can focus their further attention and efforts on optimizing those webpages which are underperforming, where the marketers' further efforts are more likely to produce a greater relative return.

Performance in this context can include one or more of a number of measurable parameters, such as conversion rates (“click-throughs”, or lead generations, for example), user time spent on the webpage, monetary value of click-through activities, etc. In the case of online marketing campaigns, the number and extent of “click-throughs” and lead generations are typically of particular interest, and we shall discuss and illustrate the present invention in such context.

### SUMMARY OF THE INVENTION

Disclosed herein is a computer-implemented method and system for ranking and comparing the performance of a webpage in connection with an online marketing campaign in relation to its closest webpage peers. Disclosed herein is a cloud-based machine learning method and system for mapping the text and language content of a webpage to a topic vector which gives memberships in a set of topics, capturing the subject matter of webpages.

Utilizing topic memberships, the present invention can be used to identify a neighborhood of webpages (sometimes referred to herein as the “neighborhood set”) that are most similar to a given webpage. This in turn may be used to gauge said webpage's conversion performance (or such other performance statistic, as the case may be) relative to the neighborhood set of webpages. This information can be very valuable to marketers in the context of managed online marketing campaigns. The information can then be used by marketers to optimize their workflow, for example to focus their efforts on the most underperforming webpages, as well as to save them time from over-optimizing and over-engineering already high performing webpages, thereby increasing the efficiency and effectiveness of marketing campaigns and increasing revenue.

In accordance with an aspect of the present invention, disclosed herein is a computer-implemented method and system for determining the performance of an example webpage relative to that of its peers, comprising the steps of: (i) selecting a modeling set of webpages; (ii) applying a topic modeling processing step based on the content of the modeling set of webpages, in order to build a topic model based on the modeling set of webpages, wherein the topic model consists of a list of topics, wherein for each topic, a probability distribution of the most probable words in relation to that topic is determined, and wherein the topic model can generate a topic vector for any given webpage; (iii) selecting a sample set of webpages for which performance criteria is available; (iv) determining a topic vector for each webpage of the sample set of webpages based on and generated from the built topic model; (v) identifying an example webpage; (vi) determining the topic vector for the example webpage based on and generated from the built topic model; (vii) computing a distance/similarity measure between the topic vector of the example webpage and the topic vectors for each webpage of the sample set; (viii) identifying a neighborhood set of webpages most similar to the example webpage based on the distance/similarity measure; (ix) comparing the performance criteria of the example webpage against that of the neighborhood set of webpages; and x) outputting a rank or grade of the example webpage. The rank or grade of the example webpage indicates whether the example webpage's performance is underperforming relative to its nearest webpage peers. The performance criteria can be the webpage conversion rate. The topic modeling processing step can employ a Latent Dirichlet Allocation model. The topic modeling processing step can comprise LDA with Collapsed Gibbs Sampling. The topic modeling processing step may be one or more selected from: structural topic modeling; dynamic topic modeling and hierarchical topic modeling. The entire list of topics generated from the topic modeling processing step may be used as the topics for the topic model. The topic modeling processing step can additionally comprise one or more pre-processing techniques to refine the topic model. The pre-processing techniques can comprise one or more techniques selected from the group of: elimination of stop words; Porter stemming; and term frequency-inverse document frequency.

The above method may be applied over a plurality of example webpages in order to assess a portfolio of webpages that are underperforming relative to their nearest peers. Also disclosed herein is a computer system and a computer program product for carrying out the above-described method steps.

### BRIEF DESCRIPTION OF THE DRAWINGS

FIG. 1 is a simplified diagram representing a computer system on which embodiments of the present invention may be implemented.

FIG. 2 is a flowchart illustrating the process of building a topic model from a sample set of webpages.

FIG. 3 is a flowchart illustrating the process of determining vector memberships for a webpage.

FIG. 4 is a flowchart illustrating the process of determining a conversion rank for a webpage.

FIG. 5 is a flowchart illustrating a method in accordance with one aspect of the invention.

### DETAILED DESCRIPTION OF THE INVENTION

A detailed description of one or more embodiments of the present invention is provided below along with accompanying figures that illustrate the principles of the invention. As such, this detailed description illustrates the present invention by way of example and not by way of limitation. The description will clearly enable one skilled in the art to make and use the invention, and describes several embodiments, adaptations, variations and alternatives and uses of the invention, including what is presently believed to be the best mode and preferred embodiment for carrying out the invention. It is to be understood that routine variations and adaptations can be made to the invention as described, and such variations and adaptations squarely fall within the spirit and scope of the invention. For the purpose of clarity, technical material that is known in the technical fields related to the invention has not been described in detail so that the invention is not unnecessarily obscured.

The term “computer” can refer to any apparatus that is capable of accepting a structured input, processing the structured input according to prescribed rules, and producing results of the processing as output. Examples of a computer include: a computer; a general purpose computer; a desktop computer, a network computer, a laptop computer; a computer on a smartphone or other portable device, a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network. The techniques described herein may be implemented by one or more special-purpose computers, which may be hard-wired to perform the techniques, or which may include digital electronic devices such as one or more application-specific integrated circuits (ASICs) or field programmable gate arrays (FPGAs) that are persistently programmed to perform the techniques, or which may include one or more general purpose hardware processors programmed to perform the techniques pursuant to program instructions in firmware, memory, other storage, or a combination. Such special-purpose computers may also combine custom hard-wired logic, ASICs, or FPGAs with custom programming to accomplish the techniques.

The term “computer-readable medium” may refer to any storage device used for storing data accessible by a computer, as well as any other means for providing access to data by a computer. Examples of a storage-device-type computer-readable medium include: a magnetic hard disk; a solid state drive; a floppy disk; an optical disk, such as a CD-ROM and a DVD; a magnetic tape; or a memory chip.

The term “software” can refer to prescribed rules to operate a computer. Examples of software include: software; code segments; instructions; computer programs; and programmed logic.

The term a “computer system” may refer to a system having a computer, where the computer comprises a computer-readable medium embodying software to operate the computer.

Cloud computing, as used herein, refers to anything that involves delivering hosted services over the Internet. The term “cloud” often refers to the Internet and more precisely to some datacenter full of servers that is connected to the Internet. A cloud can be a wide area network (WAN) like the Internet or a private, national, or global network. The term can also refer to a local area network (LAN) within an organization. As used herein, a “cloud” is any communications network.

Disclosed herein, is a multi-part, machine learning and reporting system in the field of applied machine learning for online marketing optimization and analytics. The present invention involves a machine learning model in the field of unsupervised learning, utilizing techniques in topic modelling.

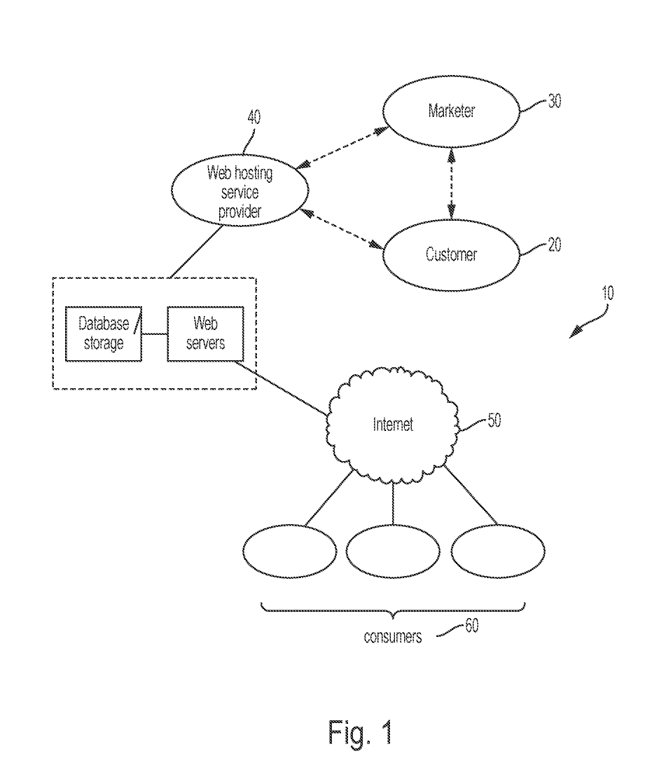

FIG. 1 is a simplified representation illustrating the operation of a conventional webpage hosting service 10, in conjunction with which an aspect of the present invention may be implemented. A customer 20 wishing to promote its products/services by way of an online marketing campaign, engages an online marketer 30, which may handle various aspects of the online marketing campaign, for example, such as webpage creation and management, generating internet traffic to such webpages, lead generation and follow-up, monitoring performance/effectiveness of such activities, etc. The created webpages are hosted (which may involve, for example, dedicated hosting or shared hosting) by a web hosting service provider 40, and made available to potential consumers 60 via the Internet 50 when such consumers are directed to visit the customer's webpages. Although the marketer 30 that provides the webpage ranking method and system disclosed herein is shown in FIG. 1 as separate from the web hosting service provider 40, it is contemplated that the web hosting service provider 40 may actually provide the online marketing/webpage service to the customer 20. Although not explicitly shown as such, it should be understood that the interactions and communications between the customer 20, marketer 30 and the web hosting service provider 40 typically will occur via the Internet or other communications network (although they can also occur in-person or by telephone, for example).

Although not specifically illustrated herein, it is to be understood that an embodiment of the present invention may be implemented on a computer or computer system. The computer can include a bus or other communication mechanism for communicating information, and a hardware processor coupled with bus for processing information. The computer may also include a memory coupled to the bus for storing information and instructions to be executed by the processor. Such instructions, when stored in storage media accessible to the processor, renders the computer into a special-purpose machine that is customized to perform the operations specified in the instructions. The computer can further include a read only memory (ROM) or other static storage device coupled to the bus for storing static information and instructions for the processor. A storage device may be provided and coupled to the bus for storing information and instructions. The computer may also be coupled via the bus to a display or screen for displaying information to a computer user. The computer may implement the techniques described herein using customized hard-wired logic, one or more ASICs or FPGAs, firmware and/or program logic which in combination with the computer system causes or programs the computer to be a special-purpose machine. According to one embodiment, the techniques herein are performed by a computer in response to the processor executing one or more sequences of one or more instructions contained in the memory. Such instructions may be read into the memory from another storage medium, such as a storage device. Execution of the sequences of instructions contained in memory causes the processor to perform the method steps described herein. In alternative embodiments, hard-wired circuitry may be used in place of or in combination with software instructions.

In one aspect of the present invention, the computer-implemented method and system utilizes a topic modeling processing step that may comprise Latent Dirichlet Allocation (LDA), structural topic modeling, dynamic topic modeling, correlated topic modeling, hierarchical topic modeling, or latent semantic indexing. Where the topic modeling processing step utilized is LDA, this will include a step such as Collapsed Gibbs Sampling or Variational Expectation-Maximization. In a preferred embodiment, the topic modeling processing step involves LDA with Collapsed Gibbs Sampling.

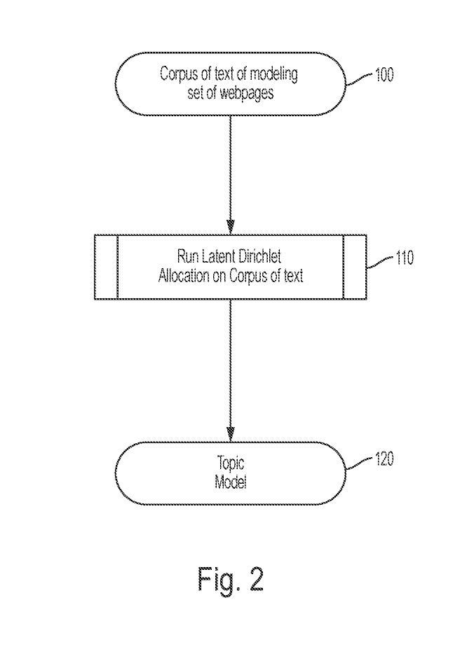

FIG. 2 is a flowchart illustrating an exemplary process of building a topic model from a large collection of webpages (also referred to herein as a “modeling set” of webpages). It is understood that the number of webpages in the modeling set used to build the topic model can vary considerably. In practice, a suitable number of webpages for the modeling set can be of the order of between 10,000 to over 400,000 webpages. Generally speaking, the larger the modeling set, the more detailed the resulting topic model is (i.e. the larger vocabulary it has); in theory, there is no upper limit in terms of the number of webpages that could be used for the modeling set. Firstly, the corpus of text 100 of the modeling set of webpages is taken. A topic modeling processing step 110 such as LDA is run against the corpus of text 100 of this modeling set of webpages in order to build a “topic model” 120 which consists of a collection of numbered “topics” (e.g. topic 1, topic 2, . . . ). Preferably, LDA is used for the topic modeling processing step, but other similar methods such as structural topic modeling, dynamic topic modeling, correlated topic modeling, or hierarchical topic modeling may also be used. By way of illustration for example, the subject matter of the webpages could include, but is not limited to, travel websites, resume and job building services, pest control, software-as-a-service applications, mortgage services, online education programs, cosmetic healthcare, business consulting, political causes, home improvement services, event registration, and discount offers.

Each topic consists of a probability distribution over a vocabulary of words whereby the most probable words in that topic are organized at the top. For example, a topic focused on travel would likely contain the words “hotel” or “vacation” at a higher probability than the word “mortgage”. Note that each topic does contain the entire vocabulary though, and said vocabulary is determined by the modeling set of webpages. Either every word present in the modeling set of webpages may be used, or, optionally, certain pre-processing techniques may be employed to refine the list of words; techniques that are known in the art include for example, elimination of stop words (common with words with little information gain, e.g. “the”) and/or elimination of most common words, or other more involved techniques such as Porter stemming or term frequency inverse document frequency (tf-idf).

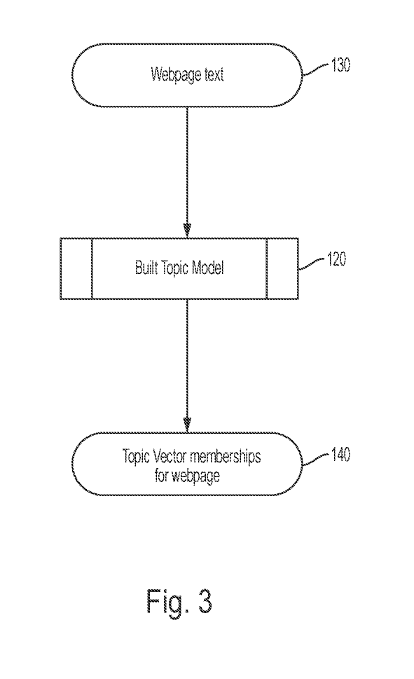

FIG. 3 is a flowchart illustrating the process of determining vector memberships for a webpage. Given a topic model 120, for each webpage of the sample set, the invention allows a mapping from the relatively large feature space of pure text to the smaller space of topics, more specifically a vector of membership in the topics with an appropriate normalization (including but not limited to unit normalization) called a “topic vector” 140. For example, a webpage advertising a webinar on travel tips may be given a topic vector value of 0.7 in respect of a topic on travel, and a topic value of 0.3 in respect of a topic on webinars (which represents the webpage's 70% membership in a topic focused on travel, and 30% on a topic focused on webinars). The details will depend on the specific webpage in question and the detailed topic model (i.e. how it was built, how many topics were chosen to be in it, etc.). For each webpage, its topic vector represents its membership in each of the topics of the topic model—in essence, the topic vector reflects the overall subject matter for a webpage.

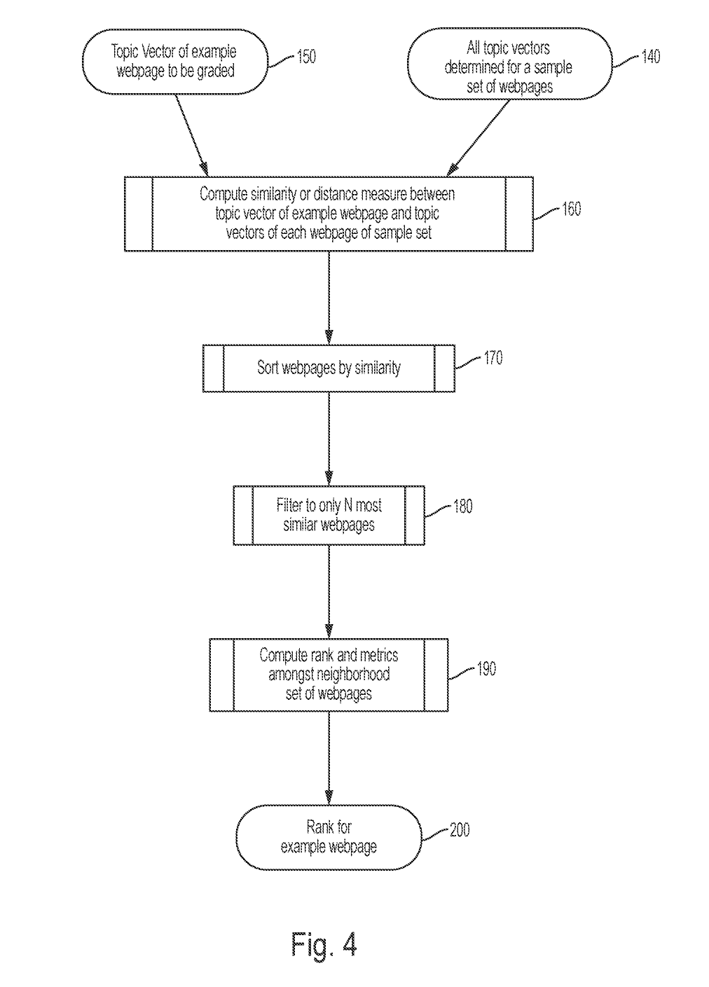

FIG. 4 is a flowchart illustrating the process of determining a conversion rank for an example webpage (i.e. the particular webpage that is of interest, and which is to be ranked/graded). The topic vector of the example webpage can be determined as described above (step 150). A vector space of topic vectors can be imbued with a “metric” or “distance/similarity measure” on it, used to compute a notion of distance or similarity between any two vectors (step 160). This includes, but is not limited to cosine similarity, Euclidean distance and Manhattan distance. Weighted, i.e. curved space metrics (non-Euclidean) also can be used. As an example, consider cosine similarity. If we have two topic vectors (for two webpages A and B that are each n dimensional positive, real vectors, that is, e.g. A=(A₁, A₂ . . . Aₙ). We define the cosine similarity between the two as:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} \qquad ( 1 )$$

In general, cos θ□(−1, 1) but if the vectors are real and positive, we have cos θ□(0, 1), with 1 being maximally similar.

Given a metric, a single example webpage, and a collection of all other webpages, the metric can be used to compute a local neighborhood of the most similar or nearby webpages in the topic space (i.e. in terms of subject matter) of a specified number, e.g. the 1000 most similar pages to the example page. This local neighborhood represents the most similar webpages by meta-topic and captures the set of other webpages most like it. As shown in FIG. 4, this can be done by sorting the sample set of webpages according to their similarity to the example webpage (step 170). This subset can then be filtered to identify the subset of N (specified number) most similar webpages (step 180).

Given the local neighborhood of webpages, and a means to score the performance of each webpage (step 190), the invention can be used to rank/grade or predict the example webpage's performance relative to the sample set (step 200). (Performance can include, but is not limited to, the actual conversion rate of the webpages over a given time period of time, or the score prediction from a separate machine learning model; it should be understood, however, that any of a number of measures of webpage performance can be used, depending on what quality of webpages a user might wish to compare against other similar webpages).

For example, in a sample set of 1000 webpages, if the example webpage outperforms 100 webpages and is outperformed by 900, its conversion score or percentile rank would be 10%. Given the example webpage, its local neighborhood of webpages, and its conversion score, the present invention can also be used to compute the estimated missed conversions or leads due to the example webpage not performing at its maximum “conversion potential”. Given the maximum conversion potential, and the approximate monetary value of a lead for the given company, the invention can be used to estimate the amount of missed potential revenue for the example webpage.

Given a customer with multiple online marketing webpages in a portfolio, the invention can be used to compute the conversion score, conversion potential, estimated missed conversions, and approximate missed potential revenue for each webpage in the customer's portfolio. The invention can then be used to highlight the webpages with the highest missed potential (including but not limited to by conversion score, conversion potential, missed conversions, or missed potential revenue) to enable the customer to efficiently optimize their workflow, workload, and efforts, as well as their budget.

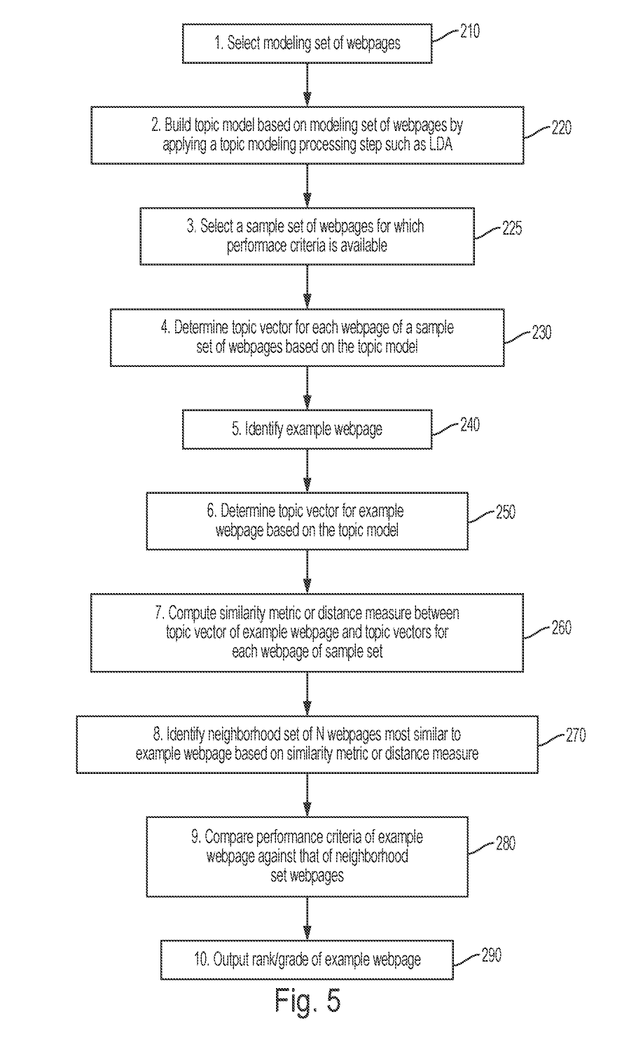

FIG. 5 is a flowchart illustrating a method in accordance with one aspect of the invention. A set of webpages (modeling set) are identified (step 210). A topic model is built/constructed for this modeling set of webpages, by employing LDA on the text thereof (step 220). Optionally, optimization and/or other preprocessing methods may also be performed on the text (as known in the art). A sample set of webpages is identified (for each of which the relevant performance statistics of interest are available/known)(step 225). The topic vector for each webpage of the sample set may be determined, with reference to the topic model (step 230). An example webpage, for which a performance ranking or grading is desired, is identified (step 240). It is contemplated that the example webpage may be selected/identified for assessment in a number of different scenarios. For example, it may be initiated as a regularly scheduled website reporting function, at the request of a specific user (such as the owner of the webpage or by a marketer who is managing the webpage or online marketing campaign for the owner), or it may be initiated as part of the service of a webpage hosting service. Once the example webpage is identified, the topic vector for the example webpage is determined with reference to the topic model as constructed (step 250).

The similarity (in terms of subject matter) of the example webpage to each webpage of the sample set is determined. This is done by computing the similarity metric or distance measure between the example webpage and each webpage of the sample set, by comparing the topic vector of the example webpage and the topic vector of each webpage of the sample set (step 260). From the distance/similarity measure, a neighborhood of N number of webpages that are most similar to the example webpage can be identified (step 270). With this neighborhood set of most similar webpages, the webpage performance (such as conversion rates, “click-throughs” or lead generations) for the example webpage may be compared against that of the neighborhood set of webpages (provided the relevant performance information is available for the neighborhood set of webpages) (step 280). The performance rank or grade of the example webpage as compared against its nearest peers, may then be provided as an output (e.g. to the user requesting such, and/or to a marketer to identify which specific webpages are underperforming). Optionally, as mentioned above, the output may also be provided in the form of the approximate cost of a webpage's underperformance as compared to its peers. In another aspect, the described method may also be used to predict the performance of an example webpage, i.e. what should the performance of the webpage be if it performs like its closest webpage peers.

It will be appreciated that variants of the above-disclosed and other features and functions, or alternatives thereof, may be combined into many other different devices, systems and/or applications. Various presently unforeseen or unanticipated alternatives, modifications, variations, or improvements therein may be subsequently made by those skilled in the art, which are also intended to be encompassed by the following claims.

1. A computer-implemented method for determining the relative performance criteria of an example webpage, comprising the steps of, at a computer:
(i) selecting a modeling set of webpages;
(ii) applying a topic modeling processing step based on the content of the modeling set of webpages, to construct a topic model based on the modeling set of webpages, wherein the topic model consists of a list of topics, and wherein for each topic, a probability distribution of the most probable words in relation to that topic is determined;
(iii) selecting a sample set of webpages for which website performance criteria is available;
(iv) for each webpage in the sample set of webpages, determining a topic vector for each such webpage based on the topic model;
(v) identifying the example webpage;
(vi) determining the topic vector for the example webpage, based on the topic model;
(vii) computing a distance/similarity measure between the topic vector of the example webpage and the topic vectors for each webpage of the sample set;
(viii) identifying a neighborhood set of webpages most similar to the example webpage based on the distance/similarity measure;
(ix) comparing the performance criteria of the example webpage against that of the neighborhood set of webpages; and
x) outputting a rank or grade of the example webpage,
wherein the rank or grade of the example webpage corresponds to the relative performance criteria of the example webpage relative to the neighborhood set of webpages.

2. The method of claim 1, wherein the performance criteria is webpage conversion rate.

3. The method of claim 1, wherein, the topic modeling processing step comprises Latent Dirichlet Allocation (“LDA”).

4. The method of claim 1, wherein the topic modeling processing step comprises Latent Dirichlet Allocation (“LDA”) with Collapsed Gibbs Sampling.

5. The method of claim 1, wherein the topic modeling processing step is one or more selected from the group of: structural topic modeling; dynamic topic modeling and hierarchical topic modeling.

6. The method of claim 1, wherein the entire list of topics generated from the topic modeling processing step are used as the topics for the topic model.

7. The method of claim 1, wherein the topic modeling processing step additionally comprises one or more pre-processing techniques to refine the topic model.

8. The method of claim 7, wherein the pre-processing techniques comprise one or more selected from the group of: elimination of stop words; Porter stemming; and term frequency-inverse document frequency.

9. The method of claim 1, wherein the distance/similarity measure is calculated using one or more selected from the group of: cosine similarity, Euclidean distance and Manhattan distance.

10. A computer system for determining the relative performance criteria of an example webpage, the computer system comprising:
a processor; and
a non-transitory storage medium comprising program logic for execution by the processor and causing the processor to perform actions comprising the steps of:
(i) selecting a modeling set of webpages;
(ii) applying a topic modeling processing step based on the content of the modeling set of webpages, to construct a topic model based on the modeling set of webpages, wherein the topic model consists of a list of topics, and wherein for each topic, a probability distribution of the most probable words in relation to that topic is determined;
(iii) selecting a sample set of webpages for which website performance criteria is available;
(iv) for each webpage in the sample set of webpages, determining a topic vector for each such webpage generated from the topic model;
(v) identifying the example webpage;
(vi) determining the topic vector for the example webpage, generated from the topic model;
(vii) computing a distance/similarity measure between the topic vector of the example webpage and the topic vectors for each webpage of the sample set;
(viii) identifying a neighborhood set of webpages most similar to the example webpage based on the distance/similarity measure;
(ix) comparing the performance criteria of the example webpage against that of the neighborhood set of webpages; and
x) outputting a rank or grade of the example webpage,
wherein the rank or grade of the example webpage corresponds to the relative performance criteria of the example webpage relative to the neighborhood set of webpages.

11. The system of claim 10, wherein the performance criteria is webpage conversion rate.

12. The system of claim 10, wherein, the topic modeling processing step comprises Latent Dirichlet Allocation (“LDA”).

13. The system of claim 10, wherein the topic modeling processing step comprises Latent Dirichlet Allocation (“LDA”) with Collapsed Gibbs Sampling.

14. The system of claim 10, wherein the topic modeling processing step is one or more selected from the group of: structural topic modeling; dynamic topic modeling and hierarchical topic modeling.

15. The system of claim 10, wherein the entire list of topics generated from the topic modeling processing step are used as the topics for the topic model.

16. The system of claim 10, wherein the topic modeling processing step additionally comprises one or more pre-processing techniques to refine the topic model.

17. The system of claim 16, wherein the pre-processing techniques comprise one or more selected from the group of: elimination of stop words; Porter stemming; and term frequency-inverse document frequency.

18. The system of claim 10, wherein the distance/similarity measure is calculated using one or more selected from the group of: cosine similarity, Euclidean distance and Manhattan distance.

19. A computer program product comprising a non-transitory computer-readable storage medium storing computer executable instructions thereon that, when executed by a computer, perform the method steps of claim 1.

20. A computer program product comprising a non-transitory computer-readable storage medium storing computer executable instructions thereon that, when executed by a computer, perform the method steps of claim 2.

21. A computer program product comprising a non-transitory computer-readable storage medium storing computer executable instructions thereon that, when executed by a computer, perform the method steps of claim 6.

22. A computer program product comprising a non-transitory computer-readable storage medium storing computer executable instructions thereon that, when executed by a computer, perform the method steps of claim 9.
